(19) United States
(12) Patent Application Publication
(10) Pub. No.: US 2005/0136742 A1
(43) Pub. Date: Jun. 23, 2005

(54) Removable computer peripheral cartridge and related system and method

(76) Inventor: Thomas Szolyga, Saratoga, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/738,755

(22) Filed: Dec. 17, 2003

(51) Int. Cl. H01R 24/00

(52) U.S. Cl. 439/630

(57) ABSTRACT

A cartridge includes a first connector such as an HCC connector, includes a HCC connector for mating with a connector disposed within a bay of a computer, and a second connector, such as a USB connector, for connecting to an external connector of the computer or of another computer. This scheme allows one to externally connect the cartridge to a computer with a cable, without the need for a special adapter.

### BACKGROUND

Some computers have removable cartridges that can be used with other computers. Typically, a first computer has a bay for receiving a removable cartridge. Consequently, one can use the cartridge with a second computer by either inserting the cartridge into a similar bay of the second computer, or by using a cable to connect the cartridge to the second computer. For example, one may use a desktop computer to record documents onto a removable hard-disk cartridge that is inserted into a bay of the desktop computer. To view the documents with a laptop computer while on vacation, one merely connects the hard-disk cartridge (which has previously been removed from the desktop computer) to the laptop using a cable.

Typically, a removable cartridge has a high-cycle-count (HCC) connector, such as an IDE/ATA connector, that is of higher quality, and is thus more reliable, than a standard external connector such as a USB or 1394 (Firewire) connector. Consequently, a HCC connector allows one to remove and insert a cartridge into the bays of one or more computers many times without wearing out the connector.

Unfortunately, to connect a removable cartridge to a computer having no compatible bay, one typically needs a special adapter to connect the cartridge to the computer via a standard cable. For example, suppose one wants to connect the cartridge to a USB port of a computer. He first inserts one end of a USB cable into the computer's USB port, and then connects the other end of the cable to one end of the adapter. Then he connects the other end of the adapter to the HCC connector of the cartridge. Fortunately, the manufacturer of the cartridge typically sells such an adapter. But unfortunately, this requires one to purchase and store the adapter for the situations where he may need to connect the cartridge to a standard computer port. Also, because each type of removable cartridge typically has a type-specific HCC connector, one is required to purchase and store a different adapter for each type of removable cartridge to be ported.

### SUMMARY

In one embodiment of the invention, a cartridge includes a first connector such as an HCC connector, for mating with a connector disposed within a bay of a computer, and a second connector, such as a USB connector, for connecting to an external connector of the computer or of another computer. This scheme allows one to externally connect the cartridge to a computer with a cable without the need for a special adapter.

### BRIEF DESCRIPTION OF THE DRAWINGS

FIG. 1 is a block diagram showing the back of a cartridge having dual connectors according to an embodiment of the invention.

FIG. 2 is a modular electrical block diagram of the cartridge interface according to an embodiment of the invention.

FIG. 3 is an exploded view of a computer system that includes a computer having cartridge bays and of the cartridge of FIG. 1 according to an embodiment of the invention.

FIG. 4 is a block diagram of the computer system of FIG. 3 showing the back panels of the computer and the cartridge and showing a cable connection between the computer and the cartridge according to an embodiment of the invention.

FIG. 5a is a front view of a computer system with an external bay housing a series of the cartridges of FIG. 1 and shows a cable-connection scheme according to an embodiment of the invention.

FIG. 5b is a rear view of the computer system of FIG. 5a according to an embodiment of the invention.

FIG. 6a is a block diagram of the cartridge of FIG. 1 with a carrying handle according to an embodiment of the invention.

FIG. 6b is a block diagram of the cartridge of FIG. 1 with an actuating cam attached to the carrying handle for insertion into a computer bay according to an embodiment of the invention.

FIG. 6c is a block diagram of the cartridge of FIG. 1 with an interlock mechanism to prevent accidental removal of the cartridge from a bay during operation according to an embodiment of the invention.

### DETAILED DESCRIPTION

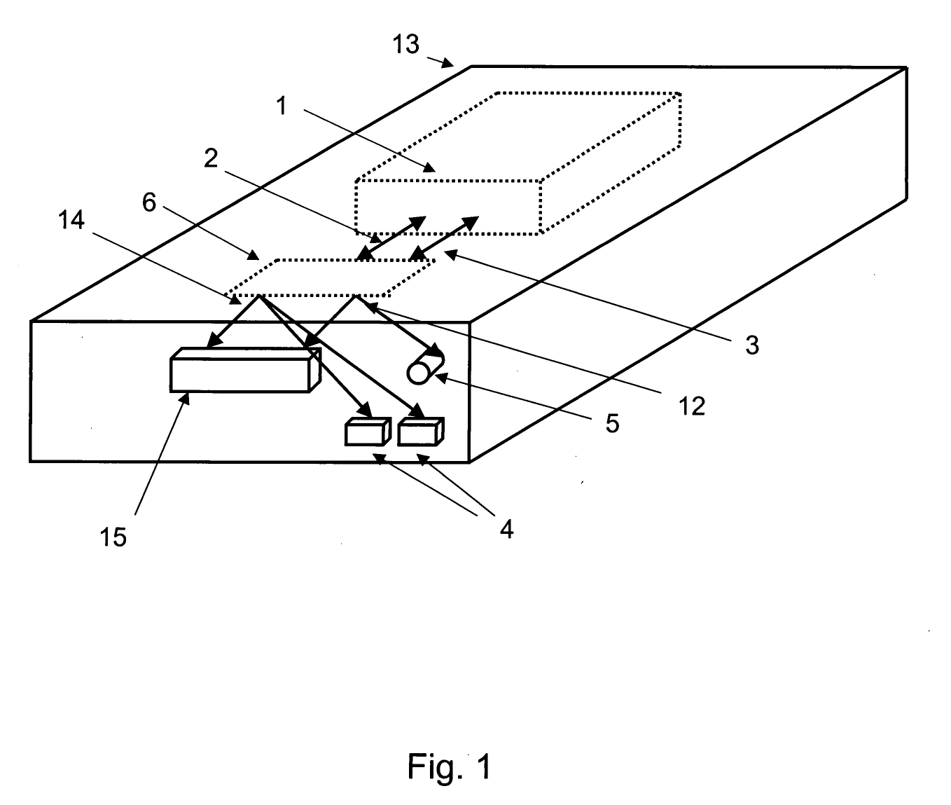

Referring to FIG. 1, in one embodiment of the invention, a cartridge 13 includes a component 1, such as a three and one-half-inch IDE/ATA hard disc, which is connected to interface electronics on a printed circuit board 6 with a standard internal HCC connector 2, such as an IDE cable, and with a standard power connector 3. The printed circuit board 6 interfaces the component 1 to external connectors 4,5, and 15 via standard data cables 14 and standard power cables 12. External to the cartridge 13, one or more—here two standard external data connectors 4, such as USB or 1394 connectors, are available for data connectivity, and the standard external power connector 5 is available for power connectivity. In addition, an external HCC connector 15 is available which provides both data and power connectivity. Because the cartridge has both standard external data connectors 4 and a HCC connector 15, when one uses the cartridge externally he can connect a cable (not shown in FIG. 1) directly to the standard external data connectors 4 without the need of an adapter to connect the cable to the external HCC connector 15.

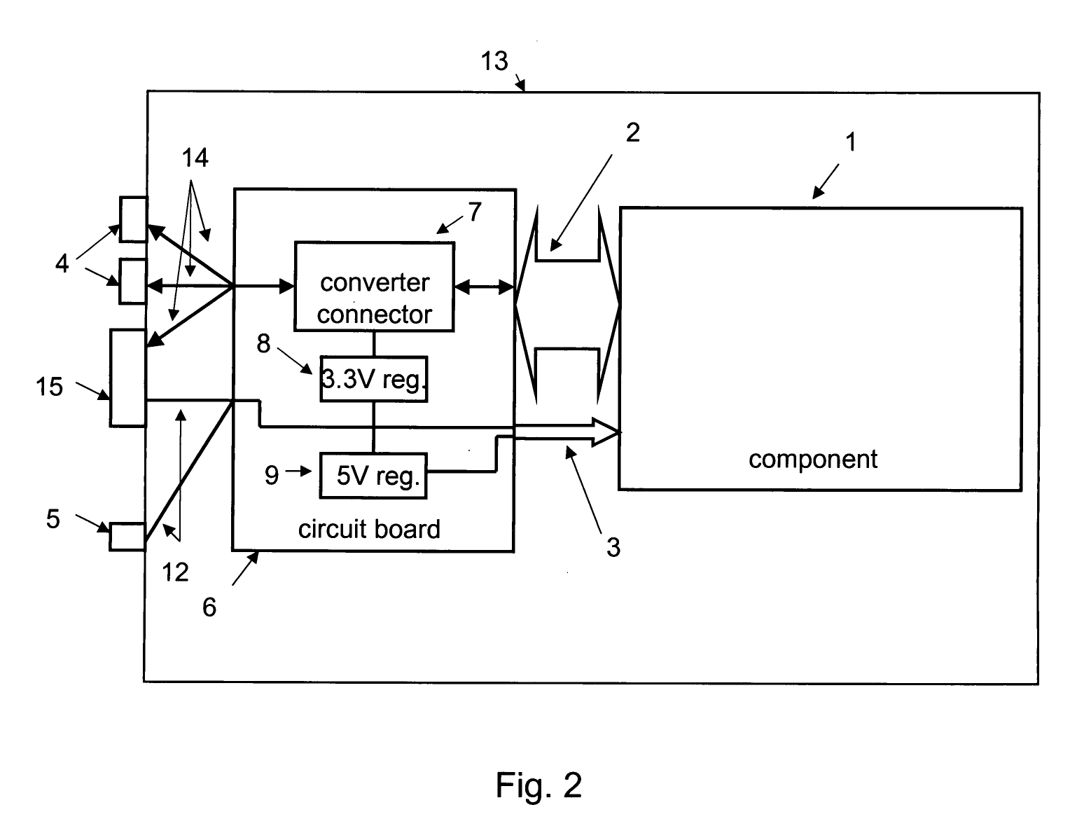

Referring to FIG. 2, the printed circuit board 6 of FIG. 1 is shown in more detail according to an embodiment of the invention. The printed circuit board 6 is an interface between the component 1 and the external connectors 4, 5 and 15. On the component side, the circuit board 6 connects to the component 1 with the standard internal HCC connector 2 and a standard internal power connector 3. On the panel side, the circuit board 6 connects to one or more standard external data connectors 4, such as USB or 1394 connectors, and also to an external HCC connector 15 via standard data cables 14. The printed circuit board 6 also connects to a standard external power connector 5, as well as to the external HCC connector 15 via standard power cables 12.

Internally, the circuit board 6 includes a converter-connector 7 that interfaces the HCC connector 2 to the standard external data connectors 4 and external HCC connector 15.

Still referring to FIG. 2, internally, the circuit board 6 also includes a 3.3-volt regulator 8 that receives the 12v supply signal from the standard external power connector 5 or the external HCC connector 15, regulates the 12V to 3.3V and, provides the 3.3V to the converter-connector 7. The circuit board 6 also includes a 5-volt regulator 9 that receives the 12V supply signal from the standard external power connector 5 or the external HCC connector 15, regulates the 12V to 5V, and provides the 5V to the standard internal power connector 3. The board also passes through the 12v supply signal from the standard external power connector 5 or the external HCC connector 15 to the standard internal power connector 3. This provides the capability to power different components with different power requirements with any of the standard component power levels, 3.3V, 5V, or 12V.

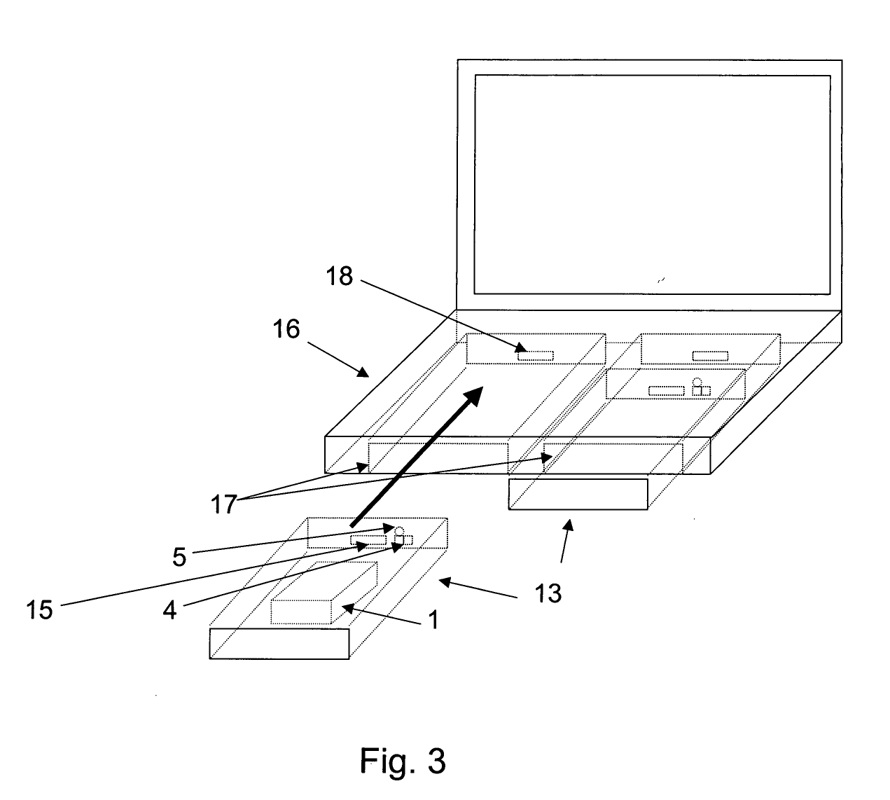

Referring to FIG. 3, according to one embodiment of the invention, a computer 16 includes several cartridge bays 17 for inserting a cartridge such as the cartridge 13 of FIGS. 1 and 2. Two cartridges 13 are shown, one partially inserted and one external to the computer 16. The external HCC connector 15 as well as the standard external data connectors 4 and the standard external power connector 5 are shown at the back of the cartridges 13. At the back of each cartridge bay 17, there is a cartridge bay HCC connector 18, which mates with the external HCC connector 15 of the respective cartridge 13. Upon the mating of the external HCC connector 15 to the cartridge bay HCC connector 18, the cartridge effectively becomes part of the computer 16. The standard external data connectors 4 and the standard external power connector 5 are not connected when the cartridge 13 is in the bay 17. Although a laptop computer is shown, it is envisioned that any type of computer can have cartridge bays that are capable of receiving the cartridge 13.

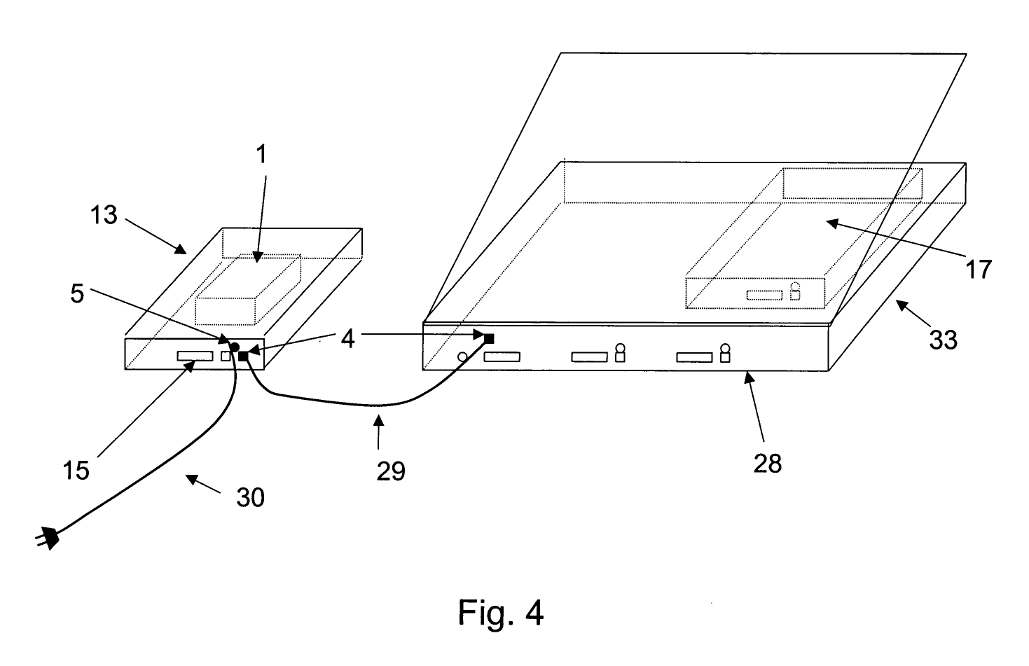

Referring to FIG. 4, in one embodiment of the invention, the cartridge 13 is external to a computer 33 with limited or no cartridge bays 17. In this external mode, the cartridge 13 is connected to the back panel 28 of the computer 33 via one of the standard external data connectors 4 and a standard external data cable 29, such as a USB or 1394 cable. Power is provided to the cartridge 13 via a standard power cord 30 connected to the external power connector 5. Alternatively, the cartridge 13 may receive power from the computer 16 via the standard external data cable 29. For example, where the component 1 within the cartridge 13 is a two-and-one-half-inch hard disk drive, then the cartridge 13 can typically draw power from the computer 16 via the standard external data cable 29. Conversely, where the component 1 is a three-and-one-half-inch hard disk drive, then the cartridge 13 typically draws power from an external source (not shown) via the cable 30 and connector 5. Consequently, because the cartridge 13 includes a standard connector 4, one can connect the cartridge 13 to a standard external connector of the computer 33 without a special adapter to couple the cable 29 to the external HCC connector 15.

Referring to FIGS. 3-4, in one embodiment, the cartridge 13 includes a three-and-one-half-inch disk drive as the component 1, which allows one to record and display video data such as movies or television programs. Suppose one wanted to store a number of television programs and then take them on a trip and view them while on the trip. One could plug the three-and-one-half-inch disk drive cartridge 13 into the cartridge bay 17 of a desktop computer (not shown) and record the television programs. Then, one could remove the cartridge 13 from the cartridge bay 17 and take the cartridge and a laptop computer 33 with him on his trip. During the trip, he connects the cartridge 13 to the laptop in an external mode with a standard external data cable 29 via one of the standard external data connectors 4. Therefore, one can view the television programs on his laptop computer 33 without the need for a special adapter to connect the cartridge 13 to the laptop.

Still referring to FIGS. 3-4, in another embodiment, one can copy the contents of a number of DVD movies onto a disk-drive cartridge 13. This allows one to take only one cartridge 13 on his trip instead of a number of DVDs.

Referring again to FIG. 4, in another embodiment on the invention, the cartridge 13 includes a component 1, which is a photo-scanner that receives and scans a photograph much like a floppy-disk drive receives and reads a floppy disk.

Referring again to FIG. 4, in yet another embodiment on the invention, the scanner is a pen-type scanner system where someone could scan something by running a light pen over it. The pen (not shown) is attached to the cartridge 13.

Referring again to FIG. 4, in yet another embodiment on the invention, the cartridge 13 includes a component 1, which is a media device such as an MP3 player.

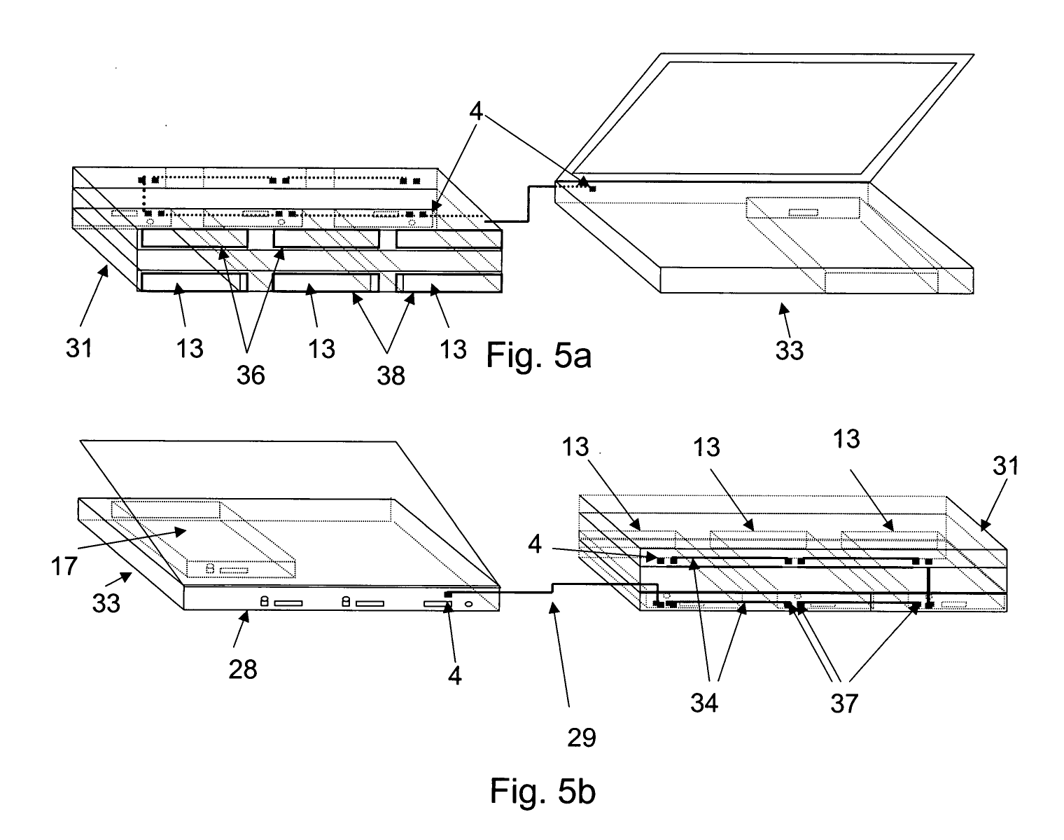

Referring to FIGS. 5a and 5b, a front view and a rear view, respectively, of an external cartridge tray 31 provides a computer 33 a means to externally connect one or more additional cartridges to the computer, according to an embodiment of the invention. The external cartridge bay 31 shown has six cartridge bays 36 (FIG. 5a), however, in other embodiments, external cartridge trays with any number of bays are possible. The external cartridge tray 31 is pre-wired at the back with in-bay standard data connectors 37 connected with integrated cables 34 such that upon full insertion of a cartridge 13 into a bay the two standard external data connectors 4 of each cartridge mate with their counterpart in-bay standard data connectors 37 (FIG. 5b). In the external cartridge tray 31, the top three bays 36 are vacant and the bottom three bays 38 are housing cartridges 13. The external cartridge tray 31 is connected to one of the standard external data connectors 4 on the back panel 28 of a computer 33 via a standard external data cable 29. This scheme allows one to plug a cartridge 13 into the next vacant slot in the external cartridge tray 31.

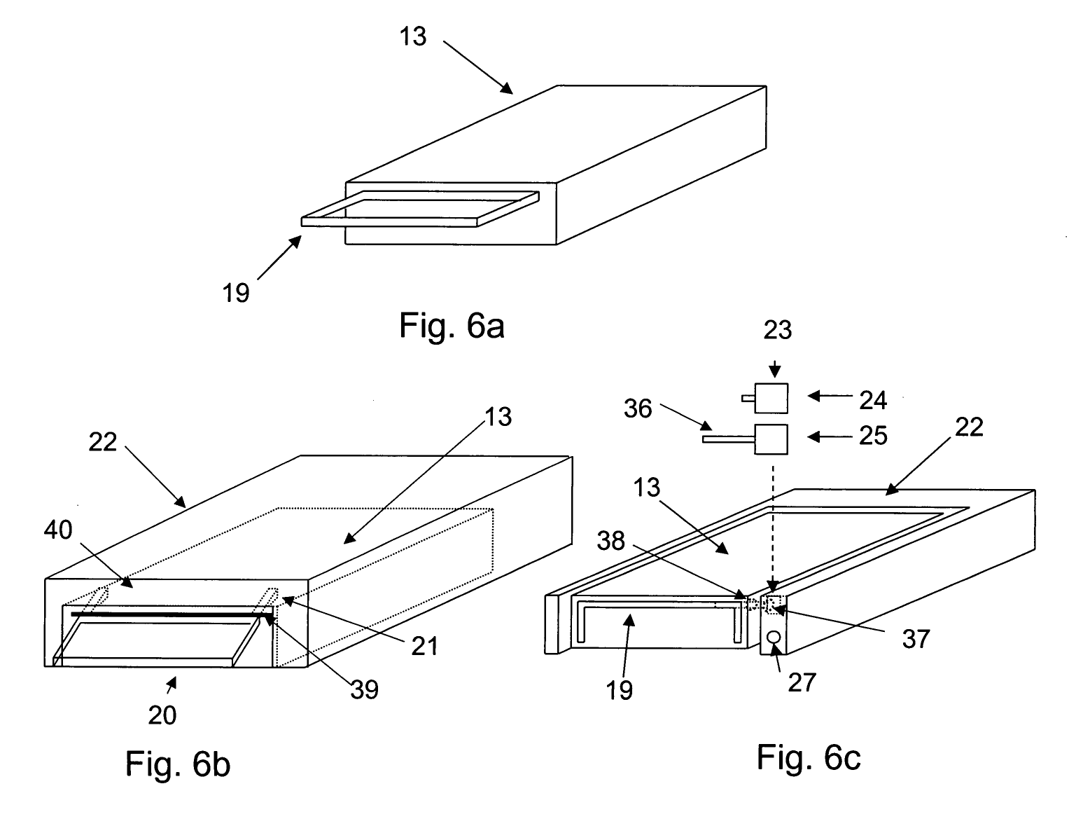

Referring to FIG. 6a, in one embodiment of the invention, the cartridge 13 includes a carrying handle 19, which allows one to carry the cartridge from one location to another.

Referring to FIG. 6b, in another embodiment, a carrying handle 20 with an actuating cam 21 for the cartridge 13 is shown. The top of the carrying handle 20 is hinged to the cartridge 13 and the carrying handle is free to rotate 90 degrees counter-clockwise from the plane of the front of the cartridge. The actuating cam 21 extends rigidly in the plane of the carrying handle 20 past the hinge 39. During an insertion operation the actuating cam 21 engages the inside of the drive bay front panel 40 of the drive bay 22 providing an added inward moment to increase the mating force. This is desirable for any power connection to ensure an adequate connection seat and thus reduce the number of power connection failures from incomplete seating. In another embodiment, a carrying handle with an actuating cam with side-to-side operation is possible.

Referring to FIG. 6c, in another embodiment of the invention, a fail-safe interlock mechanism 23 for the cartridge 13 is shown. While the cartridge 13 is being inserted into a bay 22, a rod 36 of the interlock mechanism 23 is in an unlocked position 24. After the cartridge 13 is inserted into the lockable cartridge bay 22, the mechanism is driven into a locked position 25, in which the rod 36 extends through a hole 37 in the lockable cartridge bay 22 and through a hole 38 in the cartridge 13 to prevent cartridge removal and movement of the cartridge 13 during operation mode. The interlock mechanism 23 is shown in its locked position 25 in the lockable cartridge bay 22. A release button 27 is provided to disengage the interlock mechanism 23 prior to removal of the cartridge 13. Pushing the release button 27 causes the rod 36 to retract into the unlocked position 24. When the rod 36 is retracted, the handle 19 is used to remove the cartridge 13 from the lockable cartridge bay 22.

The preceding discussion is presented to enable a person skilled in the art to make and use the invention. Various modifications to the disclosed embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

1. A cartridge, comprising:
a first connector operable to mate with a connector disposed within a bay of a computer; and
a second connector operable to connect to an external connector of a computer.

2. The cartridge of claim 1 wherein the first connector is operable to carry data and power signals.

3. The cartridge of claim 1 wherein the second connector is operable to carry data and power signals.

4. The cartridge of claim 1, further comprising a power connector.

5. The cartridge of claim 1 wherein the first connector comprises a high-cycle-count connector.

6. The cartridge of claim 1 wherein the second connector is operable to connect to the external connector of the computer via a cable that is operable to mate directly with the second connector.

7. The cartridge of claim 1 further comprising a hard-disk drive coupled to the first connector and the second connector.

8. The cartridge of claim 1 further comprising a camera coupled to the first connector and the second connector.

9. The cartridge of claim 1 further comprising a scanner coupled to the first connector and the second connector.

10. The cartridge of claim 1 wherein the second connector comprises a 1394 firewire connector.

11. The cartridge of claim 1 wherein the second connector comprises a USB connector.

12. A system, comprising:
a computer including an external connector;
a cartridge comprising;
a first connector operable to mate with a bay connector when the cartridge is inserted into a bay of the computer or of another computer; and
a second connector; and
a cable having a first end operable to mate directly with the second connector and a having a second end operable to mate directly with the external connector.

13. The system of claim 12 wherein:
the computer further comprises a bay; and
the cartridge further comprises;
a first connector operable to mate with a bay connector when the cartridge is inserted into the bay of the computer or of another computer; and
a second connector operable to connect directly to the computer when the cartridge is outside the bay.

14. The system of claim 13 wherein the cartridge further comprises:
a carrying handle; and
an actuating cam operable to engage the inside of a front panel of the bay during an insertion operation.

15. The system of claim 13 wherein the cartridge further comprises an interlock mechanism operable to prevent removal of the cartridge during operation.

16. The system of claim 13 wherein:
the computer further comprises a first hole in the interior wall of the bay; and
the cartridge further comprises:
a second hole in exterior wall of the cartridge; and
an extensible rod operable to extend through the first hole and subsequently through the second hole.

17. The system of claim 13 wherein the bay further comprises a release button operable to cause the extensible rod to retract.

18. A system, comprising:
a computer having an external connector;
a cartridge tray having an external tray connector and a plurality of cartridge bays operable to receive cartridges; and
a cable operable to mate directly with the external connector and operable to mate with the external tray connector.

19. The system of claim 18 further comprising one or more cartridges having a plurality of cartridge connectors wherein the cartridge tray further comprises;
a plurality of integrated connectors operable to mate with the cartridge connectors; and
a plurality of integrated cables connecting the cartridge bays, each with the next.

20. A method comprising:
mating a first end of a cable to an external connector of a computer;
mating a second end of the cable directly to a first connector of a cartridge having a second connector operable to mate with a connector within a bay of the computer or another computer.

21. The method of claim 20 further comprising:
inserting a cartridge into the bay of the computer or another computer;
writing media to the cartridge;
removing the cartridge from the bay of the computer;
connecting the cartridge to the computer or another computer; and
reading the media.

22. The method of claim 21 wherein inserting further comprises mating a high cycle count connector on the cartridge with a counterpart high cycle count connector disposed in the bay.

23. The method of claim 21 wherein connecting further comprises connecting a power cable to a power connector of the cartridge.

24. The method of claim 21 wherein inserting further comprises engaging an actuator cam rigidly attached to a carrying handle on the cartridge with an inside front panel of the bay; and
rotating the carrying handle toward the bay.

25. The method of claim 21 wherein inserting further comprises engaging a mechanism to hold the cartridge in the bay.
